(19) United States
(12) Patent Application Publication
(10) Pub. No.: US 2009/0120916 A1
(43) Pub. Date: May 14, 2009

(54) Through-Via Laser Reflow Systems And Methods For Surface Mount Components

(75) Inventors: Robert Bruce, Rockwell, TX (US); Brian Hogan, Plano, TX (US)

Correspondence Address: LATHROP & GAGE LC, 2345 GRAND AVENUE, SUITE 2800, KANSAS CITY, MO, 64108, US

(73) Assignee: L3 Communications Corporation

(21) Appl. No.: 11/938,634

(22) Filed: Nov. 12, 2007

(51) Int. Cl. B23K 26/34; B23K 26/02

(52) U.S. Cl. 219/121.66; 219/121.65

(57) ABSTRACT

A system and method are disclosed for remelting solder balls in the forming of electrical connections between an electrical component being mounted on a printed circuit board (PCB). Vias are formed in the PCB. Underneath the PCB, a laser is directed through the via to remelt the solder ball to make the connection. In one version, the laser is included on a positioning device. The positioning device translates the laser to a location from which it is aimed through the aperture at the solder mass. In other versions, a camera on the positioning device helps position the laser by making reference to a fiducial mark on the PCB. Further, a detector can be used to determine laser intensity by measuring the output after it passes through the via.

### BACKGROUND

A recent trend in reducing size and cost of electronic systems is the increased use of surface mount components, which mount to one side of a printed circuit board (“PCB”). Such components may require less space on a PCB, and alleviate PCB routing constraints, as compared to components having pins that mount through holes of the PCB. However, reliability of an electronic system is often determined, at least in part, by the reliability of soldered connections among devices and PCBs of the system, and it can be problematic to ensure reliable connections of surface mounted components to a PCB.

One example of a surface mount component is a Ball Grid Array (“BGA”) package that includes solder balls laid out in a grid. BGA packages may be installed by using hot, forced air or infrared heat applied to a substantial area of a PCB, or the entire PCB, to melt (or “reflow”) the solder balls. The amount of heat required to insure that all of the solder balls of a BGA are properly reflowed can create collateral damage to other adjacent components on the PCB, or damage connections between the components and the PCB.

### SUMMARY

Some embodiments disclosed include systems and methods for melting one or more solder masses. The mass, in some embodiments, is used to form an electrical connection between an electrical component and a PCB where the PCB includes an aperture (e.g., a via). The system, in one embodiment, includes a laser which is able to be directed at the solder mass through the aperture. In one embodiment the laser is attached to a translatable positioning device for the purpose of translating said laser to a location from which a beam emitted from said laser is aimed through the aperture at the solder mass.

In other embodiments a detector is used for calibration. The detector can be used to receive the beam and determine its intensity after passing through the aperture. (This is done before the component has been positioned for installation).

In other embodiments a camera is associated with said laser. The camera makes reference to a fiducial mark such that laser position is determinable when a control system receives information from said camera regarding said fiducial mark.

Embodiments of the system also include the use of an optical device. The optical device receives the laser beam and changes a characteristic of the beam. In one embodiment, the characteristic is focus.

In other embodiments, the laser is located remotely from a translatable laser positioning device. In these embodiments one or more fiber optic cables are used to deliver the laser beam emitted into one or more optical devices on the positioning device. The optical devices aim and focus the laser light for transmission at the solder. In other embodiments, a fiber optic splitter arrangement might be used to divide a single beam into many.

### BRIEF DESCRIPTION OF DRAWINGS

FIG. 1 shows a cross-sectional schematic view of one through-via laser reflow system that mounts a surface mount component to a PCB, in accord with an embodiment.

FIG. 2 shows the through-via laser reflow system, PCB and surface mount component of FIG. 1 after reflow of a solder ball.

FIG. 3 shows a cross-sectional schematic view of one through-via laser reflow system that mounts a surface mount component to a PCB, in accord with an embodiment.

FIG. 4 shows a cross-sectional schematic view of one through-via laser reflow system that mounts a surface mount component to a PCB, in accord with an embodiment.

FIG. 5 shows a cross-sectional schematic view of one through-via laser reflow system that mounts a surface mount component to a PCB, in accord with an embodiment.

FIG. 6 shows a cross-sectional schematic view of one portion of another through-via laser reflow system that mounts surface mount component 20(2) to a PCB, in accord with an embodiment.

FIG. 7 shows a cross-sectional schematic view of one portion of another through-via laser reflow system that mounts surface mount component 20(2) to a PCB, in accord with an embodiment.

FIG. 8 shows a block diagram of components of a through-via laser reflow system, in accord with an embodiment.

FIG. 9 shows a flowchart illustrating steps of a process for calibration and setup of a through-via laser reflow system, in accord with an embodiment.

FIG. 10 shows a flowchart illustrating steps of a process for installing a component to a PCB by utilizing a through-via laser reflow system to reflow solder balls, in accord with an embodiment.

### DETAILED DESCRIPTION

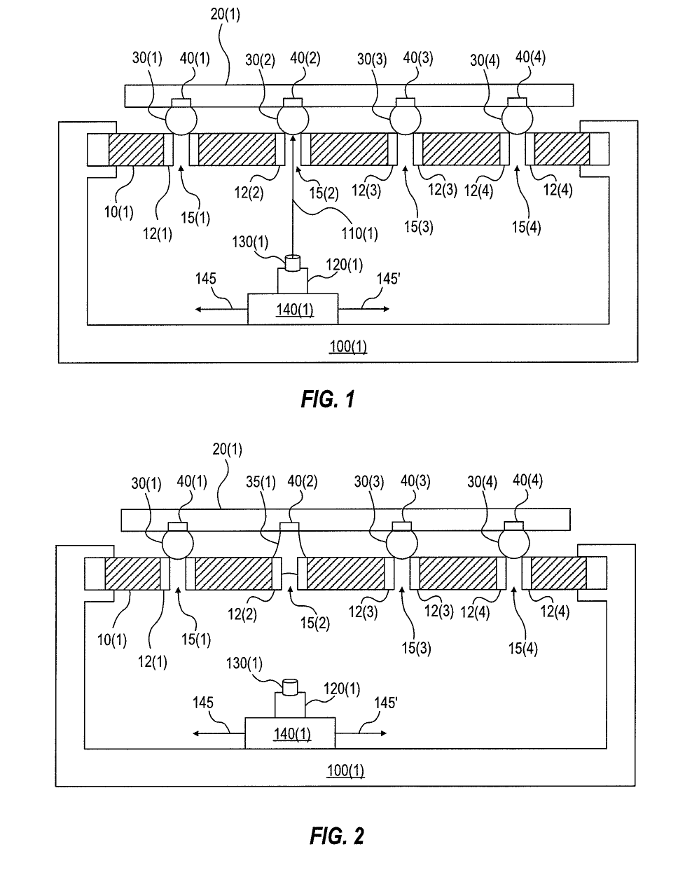

FIG. 1 shows a cross-sectional schematic view of a through-via laser reflow system 100(1) that mounts a surface mount component 20(1) to a PCB 10(1). FIG. 1 may not be drawn to scale. Component 20(1) is, for example, a Ball Grid Array (“BGA”) package that includes an arrangement of solder balls 30(1)-30(4). PCB 10(1) forms apertures 15(1)-15(4) in an arrangement that matches the arrangement of solder balls 30(1)-30(4) at electrical connection points 40(1)-40(4) of component 20(1). In the disclosed embodiment, apertures 15(1)-15(4) are vias. PCB 10(1) includes metallization 12(1)-12(4) that surrounds each of vias 15(1)-15(4), respectively, as shown. It is understood that the depiction of solder balls is illustrative and that other configurations of solder are within the scope of the present disclosure. Furthermore, the number of vias 15 and solder balls 30 depicted in the appended drawings are illustrative only; another, typically higher number and arrangement of vias 15 and solder balls 30 is within the scope of the present disclosure.

A laser 120(1) of through-via laser reflow system 100(1) emits a beam 110(1) of electromagnetic energy that reflows one of solder balls 30(1)-30(4) of component 20(1) to PCB 10(1). For example, FIG. 1 shows beam 110(1) aimed through via 15(2) so that it impinges on solder ball 30(2). Heat generated when solder ball 30(2) absorbs beam 110(1) melts solder ball 30(2), forming an electrical connection between connection point 40(2) of component 20(1) and metallization 12(2) of PCB 10(1). Via 15(2) allows direct access of beam 110(1) to solder ball 30(2) so that the heat is concentrated where it is required, thus minimizing transfer of heat to PCB 10(1) and adjacent components thereon.

Through-via laser reflow system 100(1) includes an optional mechanical positioning subsystem 140(1) that moves at least beam 110(1) in one or both of the directions of arrows 145, 145′ so that beam 110(1) aims accurately into a specific via 15 (e.g., any of vias 15(1)-15(4), or other vias 15 not shown in FIG. 1). Mechanical positioning subsystem 140(1) may include, for example, a linear stepper motor, an air bearing slider, a leadscrew system, or some other known arrangement capable of executing the desired positioning. It is understood that additional mechanical positioning subsystems (not shown) may also be utilized to position laser 120(1) in directions besides those depicted by arrows 145, 145′. For example, positioning subsystem 140(1) may move in one of the directions of arrows 145, 145′ while other such positioning subsystems move in and out of the cross-sectional plane illustrated in FIG. 1, and focusing subsystems may move laser 120(1) vertically (that is, along the direction of beam 110(1)) to adjust focus of beam 110(1) on PCB 10(1). Still other positioning subsystems may align coordinate axes of the laser (e.g., the directions of arrows 145) with coordinate axes of PCB 10(1). In another embodiment, laser could be moved in a two dimensional coordinate plane (with one dimension coming into and out of the page with respect to FIG. 1) instead of the linear movement embodiment of FIG. 1. Alternatively, mechanical positioning subsystems may move PCB 10(1) relative to system 100(1), instead of moving laser 120(1) relative to system 100(1). Also, system 100(1) may include an optical positioning subsystem (not shown) that aims beam 110(1) while leaving laser 120(1) stationary within system 100(1).

Through-via laser reflow system 100(1) may include an optical alignment subsystem (not shown) having an illumination source, a processor, and a camera for capturing an image of a PCB 10 (e.g., PCB 10(1)) and/or alignment marks thereon. The processor may perform pattern recognition on the image to determine a position of PCB 10 relative to system 100(1), in order to position subsystem 140(1) so that beam 110(1) aims at a specific via 15.

System 100(1) may include apparatus that adjusts parameters of beam 100(1) for optimum performance in various ways. For example, optics 130(1) may include a focusing subsystem that adjusts a spot size and shape of beam 110(1) and thereby compensates for (a) variations in distance between system 100(1) and PCB 10(1) and/or component 20(1), (b) variations in size and shape among vias 15, and/or (c) other manufacturing variables (e.g., composition of solder balls 30). Beam 110(1) may be a form of electromagnetic energy that performs its intended purpose, such as ultraviolet light, visible light, infrared light or microwaves. System 100(1) may include circuitry (not shown) for turning laser 120(1) on or off. Laser 120(1) may be a continuous wave laser, or may be a pulse laser. Laser 120(1) may be operable to adjust wavelength and/or power of beam 110(1). System 100(1) may include mechanical and/or optical apparatus (not shown) for diverting or absorbing beam 110(1) when beam 110(1) is not in use.

FIG. 2 shows through-via laser reflow system 100(1), PCB 10(1) and surface mount component 20(1) after reflow of solder ball 30(2). FIG. 2 may not be drawn to scale. Solder that originally formed solder ball 30(2) forms electronic connection 35(1) between connection point 40(2) of component 20(1) and metallization 12(2) of PCB 10(1).

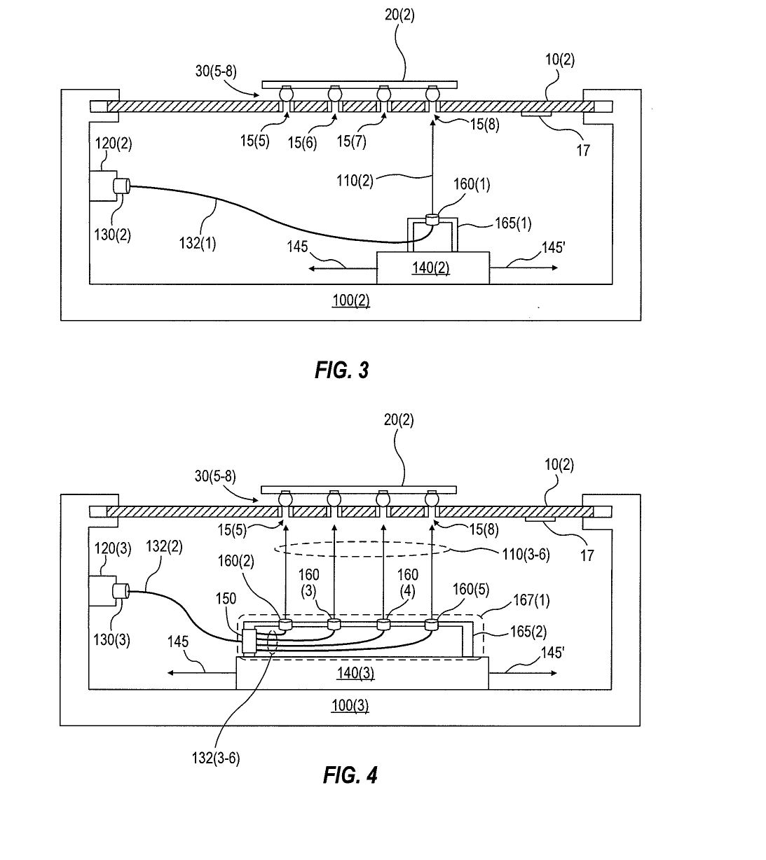

FIG. 3 shows a cross-sectional schematic view of a through-via laser reflow system 100(2) that mounts a surface mount component 20(2) to a PCB 10(2). FIG. 3 may not be drawn to scale. Component 20(2) is, for example, a BGA package that includes an arrangement of solder balls 30(5)-30(8), that matches an arrangement of vias 15(5)-15(8) in PCB 10(2). A laser 120(2) of through-via laser reflow system 100(2) emits electromagnetic energy that is focused by optics 130(2) into a fiber optic line 132(1). Optics 160(1) focuses the electromagnetic energy into beam 110(2). System 100(2) includes an optional mechanical positioning subsystem 140(2) that moves a mechanical support element 165(1) holding optics 160(1). Subsystem 140(2) moves in one of the directions of arrows 145, 145′ so that beam 110(1) aims accurately into a specific via 15 (e.g., any of vias 15(5)-15(8), or other vias 15 not shown in FIG. 3). Beam 110(2) aims through one of respective vias 15(5)-15(8) so that it impinges on one of solder balls 30(5)-30(8), generating heat that melts the solder ball to form an electrical connection between component 20(2) and PCB 10(2). System 100(2) may provide more rapid and/or precise positioning of beam 110(2) as compared to system 100(1) because fiber optic line 132(1) and optics 160(1) may present a lower mass to be moved than laser 120(1). Reliability and/or longevity of laser 120(2) may also be improved over that of laser 120(1) since laser 120(2) is not subjected to the mechanical stresses of movement.

It is understood that additional mechanical positioning subsystems (not shown) may also be utilized to position beam 110(2) in directions besides those depicted by arrows 145, 145′. For example, such positioning subsystems may move beam 110(2) in and out of the cross-sectional plane illustrated in FIG. 3, and/or may align coordinate axes of the laser (e.g., the directions of arrows 145) with coordinate axes of PCB 10(2). Alternatively, mechanical positioning subsystems may move PCB 10(2) relative to system 100(2), instead of moving laser 120(2) relative to system 100(2). Also, system 100(2) may include an optical positioning subsystem (not shown) that aims beam 110(2) while leaving laser 120(2) stationary within system 100(2). PCB 10(2) includes a fiducial mark 17 that system 100(2) can utilize to determine a relative position of positioning subsystem 140(2) (and/or other positioning subsystems, not shown) with respect to PCB 10(2); use of fiducial mark 17 is explained in connection with FIG. 6, below.

FIG. 4 shows a cross-sectional schematic view of a through-via laser reflow system 100(3) that, like system 100(2), mounts surface mount component 20(2) to PCB 10(2). FIG. 4 may not be drawn to scale. A laser 120(3) of through-via laser reflow system 100(3) emits electromagnetic energy that is focused by optics 130(3) into a fiber optic line 132(2), which couples with a fiber splitter 150. Fiber splitter 150 mounts on a positioning subsystem 140(2); line 132(2) is long enough to allow positioning subsystem 140(2) to move as necessary in the direction of arrows 145, 145′ (and in other directions, such as in and out of the cross-sectional plane illustrated in FIG. 4). Fiber splitter 150 transmits portions of the electromagnetic energy transmitted through line 132(2) into fiber optic lines 132(3)-132(6). Each of fiber optic lines 132(3)-132(6) emits a respective portion of electromagnetic energy as one of beams 110(3)-110(6) that may be shaped by optional optics 160(2)-160(5). Each of beams 110(3)-110(6) aims through one of respective vias 15(5)-15(8) so that they impinge on solder balls 30(5)-30(8), generating heat that melts solder balls 30(5)-30(8) to form electrical connections between component 20(2) and PCB 10(2).

Use of fiber splitter 150, fiber optic lines 132(3)-132(6) and optional optics 160(1)-160(4) to facilitate reflow of solder balls 30(5)-30(8) improves manufacturing throughput of system 100(3) relative to system 100(1). Again, the depiction of four beams 110 reflowing four solder balls 30 is illustrative only, it should be apparent that modifications may be made to generate any number of beams 110 to melt a corresponding number of solder balls 30. Characteristics of fiber splitter 150, of fiber optic lines 132(3)-132(6) and of optional optics 160(1)-160(4) may be individually configured to optimize reflow for solder balls and/or vias that are not identical in shape, size or solder ball composition.

Optics 160(1)-160(4), fiber optic lines 132(3)-132(6) and/or fiber splitter 150 may couple with a mechanical support element 165(2) so that they maintain alignment relative to each other while positioning subsystem 140(2) moves. Collectively, optics 160(1)-160(4), fiber optic lines 132(3)-132(6), fiber splitter 150 and support element 165(2) may form an optical subsystem (“OSS”) 167(1) that is tailored to the arrangement of vias on board 10(2). OSS 167(1) may be removable as a unit from system 100(2) by removing support element 165(2) from positioning subsystem 140(2) and disconnecting fiber splitter 150 from fiber optic line 132(2) (or by disconnecting line 132(2) from optics 130(3). OSS 167(1) and other OSSs (not shown) may install interchangeably on system 100(3) as manufacturing demands may require, for reflowing solder balls of components having different via arrangements.

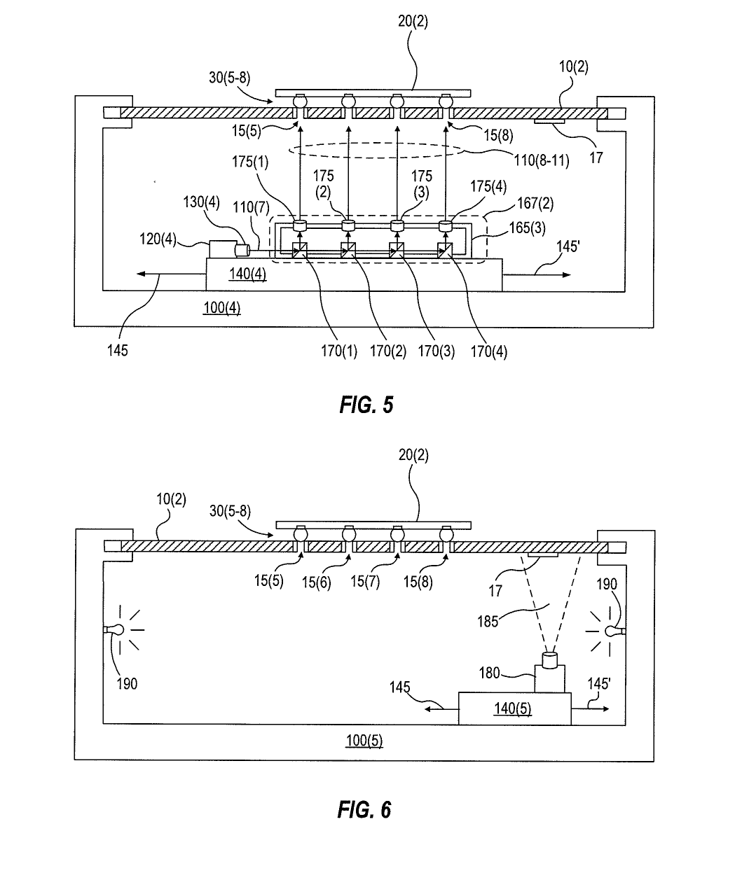

FIG. 5 shows a cross-sectional schematic view of a through-via laser reflow system 100(4) that, like systems 100(2) and 100(3), mounts surface mount component 20(2) to PCB 10(2). FIG. 5 may not be drawn to scale. A laser 120(4) of through-via laser reflow system 100(4) emits electromagnetic energy that is split by beam splitters 170(1)-170(4) into separate beams 110(8)-110(11), which may be focused by optional optics 175(1)-175(4). System 100(4) includes an optional mechanical positioning subsystem 140(4) that moves a mechanical support element 165(3) holding beam splitters 170(1)-170(4) and optional optics 175(1)-175(4). Subsystem 140(2) moves in one of the directions of arrows 145, 145′ so that each of beams 110(8)-110(11) aims accurately into a specific via 15 (e.g., one of vias 15(5)-15(8), or other vias 15 not shown in FIG. 5). Each of beams 110(8)-110(11) generates heat that melts solder balls 30(5)-30(8) to form electrical connections between component 20(2) and PCB 10(2). Again, the depiction of four beams 110 reflowing four solder balls 30 is illustrative only, it should be apparent that modifications may be made to generate any number of beams 110 to melt a corresponding number of solder balls 30.

Beam splitters 170(1)-170(4) and optics 175(1)-175(4) may couple with a mechanical support element 165(3) so that the beam splitters and optics maintain alignment relative to each other while positioning subsystem 140(4) moves. Collectively, beam splitters 170(1)-170(4), optics 175(1)-175(4) and support element 165(3) may form an OSS 167(2) that is tailored to the arrangement of vias on board 10(2). OSS 167(2) and other OSSs (not shown) may install interchangeably on system 100(4) as manufacturing demands may require, for reflowing solder balls of components having different via arrangements.

It should be apparent that system 100(4) uses free space optics (e.g., beam splitters 170(1)-170(4) and optional optics 175(1)-175(4)) analogously to system 100(3)'s use of corresponding fiber coupled optics. Use of beam splitters 170(1)-170(4) to generate beams 110(8)-110(11) to reflow solder balls 30(5)-30(8) improves manufacturing throughput of system 100(4) relative to system 100(1). Characteristics of beam splitters 170(1)-170(4) and of optional optics 175(1)-175(4) may be individually configured to optimize reflow for solder balls and/or vias that are not identical in shape, size or solder ball composition. It is appreciated that other combinations of free space optics and fiber optics may be utilized in various embodiments, and that all such combinations are contemplated by the present disclosure.

FIG. 6 shows a cross-sectional schematic view of one portion of a through-via laser reflow system 100(5) that, like systems 100(2)-100(4), mounts surface mount component 20(2) to PCB 10(2). FIG. 6 may not be drawn to scale. System 100(4) includes a mechanical positioning subsystem 140(5) that aims one or more laser beams (not shown) through respective vias 15(5)-15(8) (and/or other vias 15); each of the laser beams impinges on and melts a corresponding solder ball to form electrical connections between component 20(2) and PCB 10(2). The laser beams may be aimed by a laser alone, by fiber coupled optics, or by free space optics or by combinations thereof, as described in connection with FIG. 1 through FIG. 5; these elements are not shown in FIG. 6 for clarity of illustration.

A camera 180 mounts with positioning subsystem 140(5); camera 180 forms images of a field of view 185. Light emanates from one or more illuminators 190; camera 180 captures light that reflects from features of PCB 10(2), including fiducial mark 17. Camera 180 transmits image data of PCB 10(2) to a processor (not shown) that utilizes pattern recognition processing to determine a location of camera 180, and thus a location of positioning subsystem 140(5), with respect to fiducial mark 17. System 100(5) may utilize location information of vias 15(5)-15(8) and other vias 15 (not shown) with respect to fiducial mark 17 (e.g., information from a design database utilized to generate PCB 10(2)), along with the location of positioning subsystem 140(5) with respect to fiducial mark 17 to determine positioning information for aiming laser beams through any of vias 15.

Extensions of the technique described above will be apparent to those skilled in the art of registering positioning systems to workpieces; for example, a PCB 10 may include multiple registration marks 17 so that whose location of a positioning subsystem 140 may be determined relative to each of marks 17 in order to calculate scaling factors and correct for rotational misalignment.

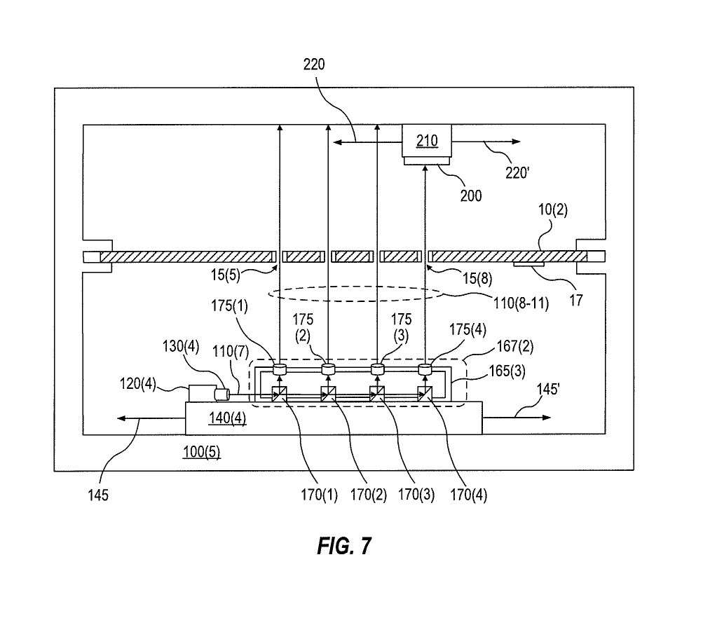

FIG. 7 shows a cross-sectional schematic view of a through-via laser reflow system 100(5) that, like systems 100(2), 100(3) and 100(4), mounts a surface mount component (not shown) to PCB 10(2). FIG. 7 may not be drawn to scale. Like system 100(4), system 100(5) includes laser 120(4), optional mechanical positioning subsystem 140(4) and mechanical support element 165(3) holding beam splitters 170(1)-170(4) and optional optics 175(1)-175(4) to form OSS 167(2). System 100(5) also includes a second, optional mechanical positioning subsystem 210 that moves in directions 220, 220′. A detector 200 that is capable of detecting electromagnetic energy from laser 120(4) mounts with positioning subsystem 210. Detector 200 is capable of detecting at least an intensity of electromagnetic energy from laser 120(4); detector 200 may also be capable of forming an image thereof. Output of detector 200 transmits to a processor (not shown) that utilizes such output to determine data of OSS 167(2) and/or PCB 10(2) that may be useful in calibration, troubleshooting, and/or to abort assembly of a compromised PCB.

For example, in a first example, system 100(5) may align to a fiducial mark 17 of PCB 10(2), then aim a laser beam through a via of PCB 10(2) (e.g., may aim laser beam 110(11) through via 15(8), as shown). Intensity and/or image data formed by detector 210 may indicate that the via is blocked (e.g., optically opaque) or not blocked. If a via is blocked, the processor may abort assembly of PCB 10(2) since the via may be entirely missing, or blocked by foreign matter; aborting assembly in such a case may preclude costly rework or scrap.

In a second example, system 100(5) may align to a fiducial mark 17 of PCB 10(2), then may move a laser beam in increments, thus “stepping” it across one or more selected vias. Intensity and/or image data formed by detector 210 at each of the “steps” may be utilized to calculate fine alignment corrections to improve a coarse alignment provided by aligning to fiducial mark 17. This procedure may be repeated, for example, at multiple vias across a PCB so that scaling, translational and rotational factors of the PCB may be determined.

In a third example, system 100(5) may align one or more laser beams at a time with detector 210 without PCB 10(2) loaded in place. Intensity and/or image data formed by detector 210 may be utilized to determine a power output of laser 120(4), and/or information of beam splitters 170(1)-170(4) or optics 175(1)-175(4) (e.g., data that may help to determine whether any of the beamsplitters or optics are degraded or misaligned, or whether any optical path thereamong is blocked).

It is also contemplated that rather than mounting on a mechanical positioning subsystem, a detector 200 may be fixedly mounted on a through-via laser reflow system, and may be mounted in a location such that lasers, optics or OSSs may be positioned so as to receive laser beams from various sources (e.g., different instances of a laser 120, optics 160 or optics 175).

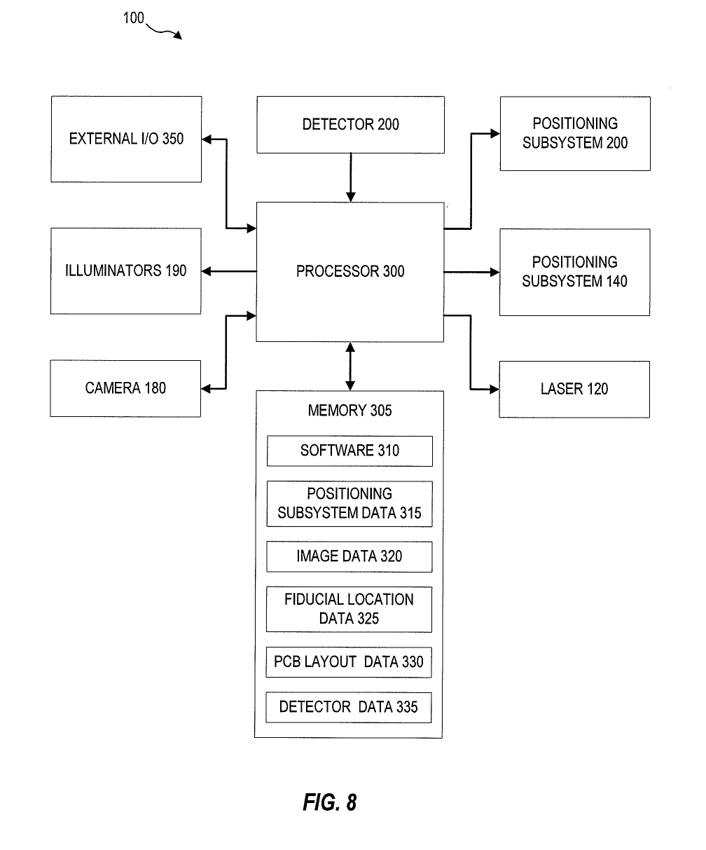

FIG. 8 shows a block diagram of components of a through-via laser reflow system 100 (e.g., any of through-via laser reflow systems 100(1)-100(5), numbers without parentheses serving to identify any of the specific examples with parentheses previously disclosed) and electrical connections there between. A processor 300 acts as a data processing and control unit for system 100. Memory 305 stores information of system 100, such as software 310, positioning subsystem data 315, image data 320, fiducial location data 325, PCB layout data 330 and detector data 335. Processor 300 may receive data from camera 180 and/or detector 200. Processor 300 may send commands to any of positioning subsystems 140 and 200, laser 120, illuminator 190 and camera 180. External I/O capability 350 may also send instructions or data to processor 300, and/or receive information therefrom. External I/O capability 350 may include a user interface for humans to exchange information with system 100 (such as a keyboard, a mouse, a joystick, image displays, alphanumeric displays, indicator lights and/or audible devices); I/O 350 may also include interfaces to other electronic devices such as, for example, Internet or other network connections.

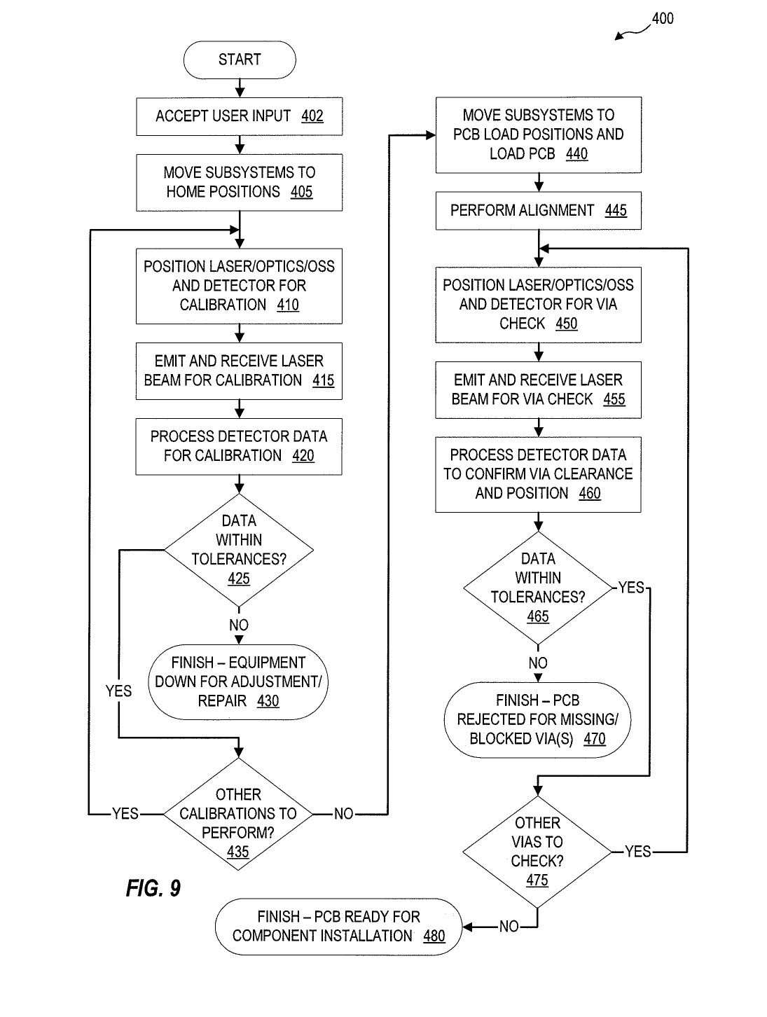

FIG. 9 shows a flowchart illustrating steps of a process 400 for calibration and setup of a through-via laser reflow system (e.g., any of through-via laser reflow systems 100(1)-100(5)). The steps of process 400 may be implemented by components of a through-via laser reflow system under control of a processor (e.g., processor 300, FIG. 8). The steps of process 400 may be performed individually or may be aggregated into automated sequences, may be executed in the order shown in FIG. 9 or in a different order, and certain steps of method 400 may be omitted, in certain embodiments.

In a step 402, the process accepts user input. User input may, for example, specify a type of PCB and/or component to be mounted thereon, start or stop single steps or automated sequences of calibration and/or processing, manually control positioning subsystems, lasers, illumination and/or cameras, or request output of information. It is appreciated that step 402 may occur many times in the execution of process 400 (as often as a user of a through-via laser reflow system feels it necessary to assert control, or request information, from such a system). An example of step 402 is processor 300 accepting user input through external I/O 350, FIG. 8. Step 405 moves subsystems of a through-via laser reflow system to home positions, such as positions that such subsystems may assume upon startup of such systems. An example of step 405 is one or more of mechanical positioning subsystems 140(1)-140(4) or 210 moving to a home position under the control of processor 300.

Steps 410 through 435 perform calibration of system 100. Step 410 positions a laser, optics, or an OSS such that a laser beam is in a predetermined position for calibration, and a detector will be in a predetermined position so as to receive the laser beam. An example of step 410 is one of mechanical positioning subsystems 140(1)-140(4) moving so that a laser beam 110 is in a predetermined position, and a mechanical positioning subsystem 210 moving so that detector 200 receives laser beam 110. Step 415 emits a laser beam, and receives the laser beam in a detector, so that attributes of a laser and/or optics can be measured. An example of step 415 is one of lasers 120(1)-120(4) emitting electromagnetic energy that is transmitted and/or directed by one or more of optics 130(1)-130(4), fiber optic line 132(1)-132(6), fiber splitter 150, beam splitters 170(1)-170(4) and optics 160(1)-160(5) or 175(1)-175(4) as one or more of laser beams 110(1)-110(15), and then detector 200 receiving the laser beam.

Step 420 processes detector data generated in step 415 for calibration purposes. An example of step 420 is processor 300 comparing actual laser power against a desired laser power and calculating a power correction that is subsequently used to adjust laser power so that a correct amount of power is received at a solder ball to be reflowed. Another example of step 420 is processor 300 processing image data to determine whether a laser beam is forming a desired spot size, and calculating position information for focusing subsystems to adjust focus. Step 425 determines whether data (e.g., raw detector data from step 415, or such data after processing in step 420) is within defined tolerances. If the data is not within tolerances, process 400 may terminate at step 430, with an indication that the system requires adjustment or repair before processing can continue. An example of step 425 is processor 300 comparing laser intensity data with defined tolerances. If the data is within tolerances, step 435 decides whether more calibration steps need to be performed. An example of step 435 is processor 300 determining whether all calibration steps of a predetermined set of calibration steps have been performed. If so, process 400 returns to step 410; if not, process 400 continues with step 440.

Steps 440 through 480 perform setup and PCB validation utilizing system 100. Step 440 moves subsystems of a through-via laser reflow system 100 to PCB load positions, and loading a PCB 10. An example of step 440 is positioning subsystems 140 moving to a predetermined load position, and a user of system 100 (or a loading machine) loading one of PCBs 10(1)-10(2) into system 100. Step 445 performs an alignment. An example of step 445 is processor 300 (a) controlling positioning subsystems 140 so that camera 180 images fiducial mark 17 on one of PCBs 10(1)-10(2); (b) controlling illuminators 190 to generate suitable lighting of fiducial mark 17; (c) controlling camera 180 to generate image information of fiducial mark 17; (d) processing image information of fiducial mark 17 to determine location and/or rotational corrections; and, optionally, (e) controlling positioning subsystems 140 to implement the location and/or rotational corrections.

In step 450, processor 300 controls a positioning subsystem to position one or more of a laser 120, optics 130(1)-130(4), beam splitters 170(1)-170(4) and optics 160(1)-160(5) or 175(1)-175(4) (or collectively, an OSS 167 incorporating such elements) to align a laser beam 110 to a via of PCB 10, and positions detector 200 to receive the laser beam. An example of step 450 is processor 300 (not shown in FIG. 7) of system 100(4) controlling positioning subsystem 140(4) to position OSS 167(2) (including beam splitter 170(4) and optics 175(4)) such that beam 110(15) aligns to via 15(8) of PCB 10(2), with detector 200 receiving beam 110(15), as shown in FIG. 7. Another example of step 450 is moving components to align a laser beam sequentially among positions defined by expected edges of a via, for example in concert with repetitions of steps 455 and 460 as explained below, to perform fine alignment of the laser beam to via locations. Step 455 emits a laser beam, and receives the laser beam in a detector, so that attributes of a via can be measured. An example of step 455 is laser 120(4) emitting electromagnetic energy that is directed by beam splitter 170(4) and optics 175(4) as laser beam 110(15), and detector 200 receiving laser beam 110(15), as shown in FIG. 7.

Step 460 processes detector data generated in step 455 for PCB validation purposes. An example of step 460 is processor 300 comparing actual laser power received in step 455 against a desired laser power (which may depend, for example, on a via size determined from a PCB design database, and may depend on a type and/or quantity of solder to be reflowed). Another example of step 460 is processor 300 processing image data to determine intensity at each of a sequence of positions, to complete a fine alignment of the laser beam to via locations, as discussed above. Step 465 determines whether data (e.g., raw detector data from step 455, or such data after processing in step 460) is within defined tolerances. If the data is not within tolerances, process 400 may terminate at step 470, with an indication that one or more vias of PCB are blocked or missing, so that continued processing may result in scrap product. An example of step 425 is processor 300 determining that laser intensity data obtained in step 455 is below a defined tolerance. If the data is within tolerances, step 475 decides whether more vias need to be checked. An example of step 475 is processor 300 determining whether any vias to be checked on a PCB 10 remain to be checked. If so, process 400 returns to step 450; if not, process 400 ends with step 480, with an aligned PCB 10 having been checked and found ready to have a component installed thereto.

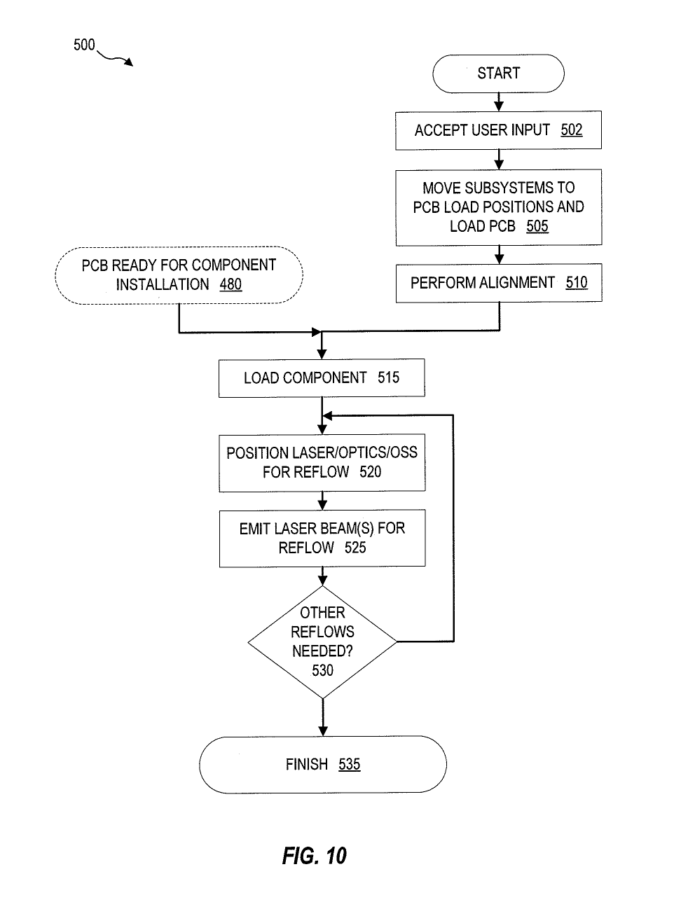

FIG. 10 shows a flowchart illustrating steps of a process 500 for installing a component 20 to a PCB 10 by utilizing a through-via laser reflow system 100 (e.g., any of through-via laser reflow systems 100(1)-100(5)) to reflow solder balls. The steps of process 500 may be implemented by components of a through-via laser reflow system under control of a processor (e.g., processor 300, FIG. 8). The steps of process 500 may be performed individually or may be aggregated into automated sequences, may be executed in the order shown in FIG. 10 or in a different order, and certain steps of method 500 may be omitted, in certain embodiments.

Process 500 can begin in one of two ways. One way is for a system 100 to first execute process 400 described above, ending at step 480; thus step 480 is shown in dashed outline in process 500. Another way of beginning process 500 is to load and optionally align a PCB utilizing steps 505 and 510; these steps are the same as steps 440 and 445, respectively, of process 400. Process 500 may also include a step 502 of accepting user input that may, for example, specify a type of PCB and/or component to be mounted thereon, start or stop single steps or automated sequences of calibration and/or processing, manually control positioning subsystems, lasers, illumination and/or cameras, or request output of information. It is appreciated that step 502 may occur many times in the execution of process 500 (as often as a user of a through-via laser reflow system feels it necessary to assert control, or request information, from such a system). An example of step 502 is processor 300 accepting user input through external I/O 350, FIG. 8.

Once a PCB is loaded, process 500 continues with step 515, which loads a component 20 to be reflowed onto a PCB 10 (e.g., loads component 20(1) onto PCB 10(1) or component 20(2) onto PCB 10(2)). An example of step 515 a user of system 100 (or a loading machine) loading a component 20 onto PCB 10. In step 520, processor 300 controls a positioning subsystem to position one or more of a laser 120, optics 130(1)-130(4), beam splitters 170(1)-170(4) and optics 160(1)-160(5) or 175(1)-175(4) (or collectively, an OSS 167 incorporating such elements) to align one or more laser beams 110 to one or more vias of PCB 10. An example of step 520 is processor 300 controlling positioning subsystem 140(3) to position OSS 167(1) to align laser beams 110(3)-110(6) to vias 15(5)-15(8), as shown in FIG. 4. Step 525 emits one or more laser beams into corresponding vias of a PCB to reflow solder balls of a component to the PCB. An example of step 525 is laser 120(3) emitting electromagnetic energy that is transmitted through fiber optic line 132(2), directed by fiber splitter 150 through fiber optic lines 132(3)-132(6) and formed by optics 160(2)-160(5) into laser beams 110(3)-110(6) which travel through vias 30(5)-30(8) and reflow solder balls 30(5)-30(8) of component 20(2), as shown in FIG. 4. Step 530 decides whether more reflows need to be performed. An example of step 530 is processor 300 checking to see whether more reflows are required to complete assembly of a PCB. If so, process 500 returns to step 520; if not, process 500 ends with step 535.

The execution of the above processes using the disclosed systems is significantly superior to the conventional methods of installing BGA packages which use hot, forced air or infrared heat. These conventional techniques involve exposing a substantial area of the PCB, or sometimes the entire PCB, to melt (or “reflow”) the solder balls. The processes disclosed here, however, do not expose the PCB to heat in remelting the BGA solder balls. Thus, there is no collateral damage done to the PCB, collateral components, or connections between the components on the PCB.

This also eliminates verification processes necessary with the prior art methods. Because the prior art processes involve heat exposure to the PCB, post-processing inspections are normally required for BGA installations. These inspections are necessary to insure that the board and related components have not been not damaged by the heat administered. The inspection process typically requires testing, X-ray observations, and other time consuming procedures necessary to ensure that the board is still fully operational. With the processes and systems here, however, only the mounted components need to be tested, since the integrity of the PC board and its already existing components are not compromised during the reflow process.

The changes described above, and others, may be made in the through-via laser reflow system described herein without departing from the scope hereof. It should thus be noted that the matter contained in the above description or shown in the accompanying drawings should be interpreted as illustrative and not in a limiting sense. The following claims are intended to cover all generic and specific features described herein, as well as all statements of the scope of the present method and system, which, as a matter of language, might be said to fall there between.

What is claimed is:

1. A through-via laser reflow system for mounting a component to a PCB, comprising
a laser for generating a beam of electromagnetic energy; and
a positioning device for positioning the laser such that the electromagnetic energy passes through a via of the PCB and impinges on a solder ball of the component to generate heat that reflows the solder ball.

2. The system of claim 1 wherein the positioning device includes a mechanical subsystem which moves the laser to a desirable position.

3. The system of claim 2 wherein the mechanical subsystem which moves the laser relative to the system.

4. The system of claim 2 wherein the mechanical subsystem which moves the PCB relative to the system.

5. The system of claim 2 wherein the mechanical subsystem aligns coordinate axes of the laser with coordinate axes of the PCB.

6. The system of claim 1 wherein the positioning subsystem includes an optical subsystem.

7. The system of claim 1 comprising an optical device useable for focusing a beam spot formed by the laser.

8. System of claim 1, further comprising an optical alignment subsystem.

9. A method of forming an electrical connection between a surface mount component and a PCB defining at least one aperture corresponding to at least one electrical connection point on said component, said method comprising:
aligning the at least one connection point with the at least one aperture corresponding to said at least one electrical connection point; and
directing at least one beam of electromagnetic energy from a laser through said at least one aperture such that the beam impinges on at least one solder mass at the corresponding connection point, and melts the solder mass to form the electrical connection.

10. The method of claim 9 comprising:
receiving said at least one beam through at least one optical device after said at least one beam is emitted from said laser to change a characteristic of said at least one beam.

11. The method of claim 10 comprising:
focusing said at least one beam using said at least one optical device.

12. The method of claim 10 comprising:
remotely locating said laser from said at least one optical device; and
delivering said beam to said optical device from said laser through a fiberoptic cable.

13. The method of claim 9 comprising:
delivering a primary beam through a primary fiberoptic cable to a splitter;
dividing said primary beam into a plurality of subbeams using said splitter;
directing each of said subbeams into one of a plurality of corresponding secondary fiberoptic cables;
receiving each of said secondary fiberoptic cables into one of a plurality of corresponding optical devices; and
melting a plurality of solder masses using said plurality of subbeams by aiming each of said plurality of subbeams using said plurality of corresponding optical devices.

14. The method of claim 9 comprising:
providing a fiducial mark on said PCB;
fixing a camera such that it moves with said laser; and
executing said aligning step using said camera by referencing said fiducial mark.

15. The method of claim 9 comprising:
calibrating said laser before said component is introduced to said component by measuring an intensity of said at least one beam after said at least one beam travels through said at least one aperture.

16. A system for melting at least one solder mass to form an electrical connection between an electrical component and a PCB, said PCB including at least one aperture, said system comprising:
a laser which is able to be directed at least one solder mass through said at least one aperture.

17. The system of claim 16 wherein said laser is attached to a translatable positioning device for the purpose of translating said laser to a location from which a beam emitted from said laser is aimed through said at least one aperture at said at least one solder mass.

18. The system of claim 17 comprising:
a detector being located in a position where, before introduction of said component and said at least one solder mass, said detector will receive and determine a characteristic of said beam for calibration purposes.

19. The system of claim 16 comprising:
a fiducial mark on said PCB; and
a camera associated with said laser such that laser position is determinable when a control system receives information from said camera regarding said fiducial mark.

20. The system of claim 16 wherein said at least one aperture is defined by metallization inside a via.
